(19) United States
(12) Patent Application Publication
(10) Pub. No.: US 2014/0247209 A1
(43) Pub. Date: Sep. 4, 2014

(54) METHOD, SYSTEM, AND APPARATUS FOR IMAGE PROJECTION

(71) Applicants: Hiroshi SHIMURA, Kanagawa (JP); Takahiro Imamichi, Kanagawa (JP)

(72) Inventors: Hiroshi SHIMURA, Kanagawa (JP); Takahiro Imamichi, Kanagawa (JP)

(21) Appl. No.: 14/186,231

(22) Filed: Feb. 21, 2014

(30) Foreign Application Priority Data
Mar. 4, 2013 (JP) 2013-042253

(51) Int. Cl. G06F 3/00

(52) U.S. Cl. CPC G06F 3/005
USPC 345/156

(57) ABSTRACT

A projection system includes: a projecting unit that projects an image; a recognition unit that recognizes an instruction action performed by a target person toward an image projected by the projecting unit and a target object based on detection information obtained by a detection apparatus; a determination unit that determines a processing condition to be applied to the image based on a recognition result by the recognition unit; a processing unit that processes the image according to the processing condition determined by the determination unit; and a control unit that controls image projection performed by the projection unit based on the image processed by the processing unit.

### CROSS-REFERENCE TO RELATED APPLICATIONS

The present application claims priority to and incorporates by reference the entire contents of Japanese Patent Application No. 2013-042253 filed in Japan on Mar. 4, 2013.

### BACKGROUND OF THE INVENTION

1. Field of the Invention

The present invention relates generally to methods, systems and apparatuses for image projection.

2. Description of the Related Art

Projection apparatuses are generally capable of displaying an image in a large area that allows a great number of people to view the image simultaneously and, accordingly, finding use for digital signage and the like in recent years. When a projection apparatus is used as such, it is desired that the projection apparatus should be interactive with a viewer. Partially in response to this need, Japanese Patent No. 3114813 discloses a technique for pointing a location on a displayed surface with a finger tip. Japanese Patent Application Laid-open No. 2011-188024 discloses a technique of executing processing according to interaction of a subject toward a projection image.

However, the conventional techniques do not allow intuitive operation.

For example, digital signage is typically employed by a shop, a commercial facility, or the like that desires to call attention of an unspecified large number of people to give advertisement, attract customers, or promote sales. Accordingly, it is desired at a site where digital signage is employed that a large number of people interacts with displayed information and is interest in contents of the information so that customer-perceived value is increased irrespective of whether the people are familiar with electronic equipment operation. In other words, in a situation where digital signage is used to deliver displayed information to an unspecified large number of people, there is a need for an environment that allows a target person to actively interact with the displayed information through intuitive operation. However, the conventional techniques are intended for users somewhat familiar with electronic equipment operation, and have a problem that the way of operation is hard to understand and handling is difficult for people unfamiliar with electronic equipment operation. Under the circumstances, there is a need for operability facilitating handling by an unspecified large number of people.

In view of the above circumstances, there is a need for methods, systems, and apparatuses for image projection that achieves operability facilitating handling by an unspecified large number of people.

### SUMMARY OF THE INVENTION

It is an object of the present invention to at least partially solve the problems in the conventional technology.

A projection system includes: a projecting unit that projects an image; a recognition unit that recognizes an instruction action performed by a target person toward an image projected by the projecting unit and a target object based on detection information obtained by a detection apparatus; a determination unit that determines a processing condition to be applied to the image based on a recognition result by the recognition unit; a processing unit that processes the image according to the processing condition determined by the determination unit; and a control unit that controls image projection performed by the projection unit based on the image processed by the processing unit.

A projection apparatus includes: a projecting unit that projects an image; a recognition unit that recognizes an instruction action performed by a target person toward an image projected by the projecting unit and a target object based on detection information obtained by a detection apparatus; a determination unit that determines processing condition to be applied to the image based on a recognition result by the recognition unit; a processing unit that processes the image according to the processing condition determined by the determination unit; and a control unit that controls image projection performed by the projection unit based on the image processed by the processing unit.

A projection method includes: projecting an image; recognizing an instruction action performed by a target person toward an image projected by the projecting unit and a target object based on detection information obtained by a detection apparatus; determining processing condition to be applied to the image based on a recognition result at the recognizing; processing the image according to the processing condition determined at the determining; and controlling image projection performed at the projecting based on the processed image obtained at the processing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example configuration of a projection system according to a first embodiment;

FIG. 2 is a schematic drawing of the projection system according to the first embodiment;

FIG. 3 is a diagram illustrating an example configuration of a PC according to the first embodiment;

FIG. 4 is a diagram illustrating an example configuration of a projection function according to the first embodiment;

FIG. 5 is a diagram illustrating a data example of determination information according to the first embodiment;

FIG. 6 is a flowchart illustrating an example of processing by an image capturing apparatus according to the first embodiment;

FIG. 7 is a flowchart illustrating an example of processing by the PC according to the first embodiment;

FIG. 8 is a flowchart illustrating an example of processing by a server according to the first embodiment;

FIG. 9 is a flowchart illustrating an example of processing by a projection apparatus according to the first embodiment;

FIG. 10 is a flowchart illustrating an example of processing for determining image processing according to the first embodiment;

FIG. 11 is a flowchart illustrating an example of processing for generating a processed image according to the first embodiment;

FIG. 12 is a diagram illustrating an example configuration of a projection function according to a first modification;

FIG. 13 is a diagram illustrating an example configuration of a projection function according to a second modification;

FIG. 14 is a diagram illustrating an example configuration of the projection apparatus according to the second modification; and

FIG. 15 is a schematic drawing of the projection system according to the second modification.

### DETAILED DESCRIPTION OF THE PREFERRED EMBODIMENTS

Embodiments of a projection system, a projection apparatus and a projection method are described in detail below with reference to the accompanying drawings.

### First Embodiment

System Configuration

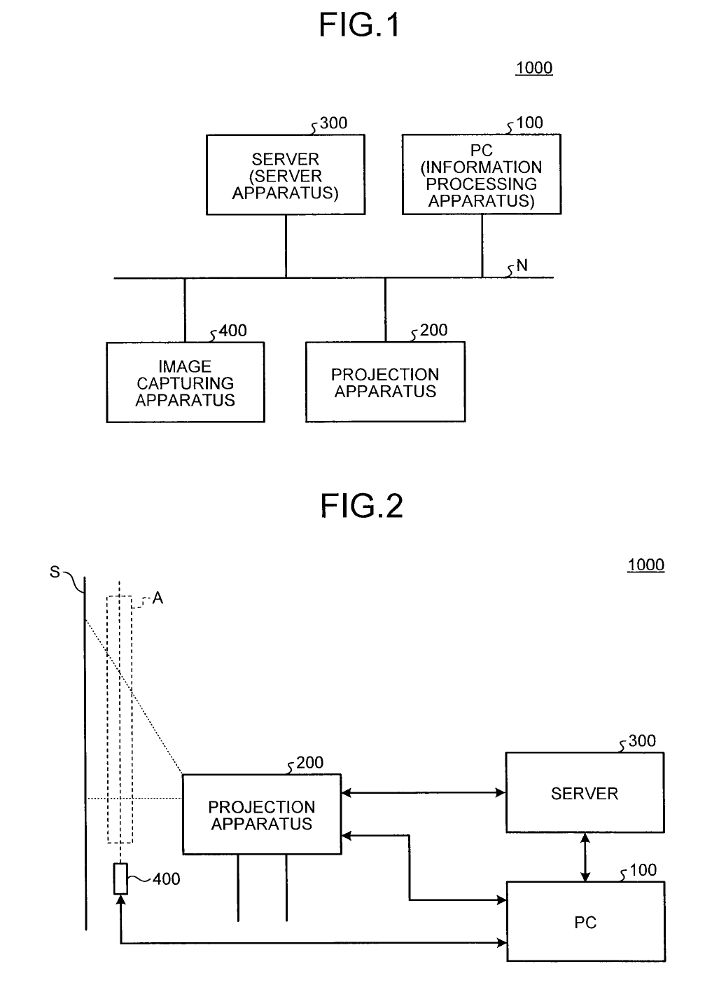

FIG. 1 is a diagram illustrating an example configuration of a projection system 1000 according to the present embodiment. As illustrated in FIG. 1, the projection system 1000 according to the embodiment includes a personal computer (PC) 100, a projection apparatus 200, a server 300, and an image capturing apparatus 400 that are connected to each other via a data transmission line N.

The PC 100 according to the embodiment includes a computing unit and has an information processing function. The PC 100 corresponds to an information processing apparatus or the like. The PC 100 can be an information terminal such as a tablet terminal. The projection apparatus 200 according to the embodiment includes an optical projection engine and has a projection function. The projection apparatus 200 can be a projector or the like. The server 300 according to the embodiment includes a computing unit and a mass-storage device and has a server function. The server 300 can be a server apparatus, a unit apparatus, or the like. The image capturing apparatus 400 according to the embodiment includes an optical image capturing engine and has an image capturing function. The image capturing apparatus 400 can be a camera, an image capturing sensor, or the like. The data transmission line N can be, for example, a network communication line of a network of various types, including local area network (LAN), intranet, Ethernet (registered trademark), and the Internet. The network communication line may be either wired or wireless. The data transmission line N can be a bus communication line of various types, including a universal serial bus (USB).

FIG. 2 is a schematic drawing of the projection system 1000 according to the embodiment. The projection system 1000 according to the embodiment provides the following services.

The projection apparatus 200 projects an image onto a projection surface S which can be a screen, for example. The image capturing apparatus 400 is arranged between the projection apparatus 200 and the projection surface S and captures an image of an operation performed by a target person and an object used when performing the operation. An image capturing area of the image capturing apparatus 400 corresponds to a detection area A where an operation performed by a target person and an object used when performing the operation are to be detected. A position of the detection area A is adjustable by changing a position of the image capturing apparatus 400. Accordingly, at a site where the projection system 1000 according to the embodiment is employed, the position of the image capturing apparatus 400 may preferably be adjusted so that an operation performed by a target person and an object used when performing the operation can be detected at an optimum position relative to the projection surface S where information is displayed. Put another way, at the site where the projection system 1000 is employed, the position of the image capturing apparatus 400 may preferably be adjusted to the position where the target person can naturally perform operation while viewing the displayed information.

The image capturing apparatus 400 arranged at such a position transmits captured image data of the detection area A to the PC 100. Upon receiving the image data, the PC 100 recognizes the operation performed by the target person from the received image data and the object used when performing the operation and performs image processing for reflecting the operation performed by the target person using the object into a projection image based on the recognition result. Thereafter, the PC 100 transmits data of the processed image to the projection apparatus 200. Simultaneously, the PC 100 requests the server 300 to transmit original data of the projection image to the projection apparatus 200. Upon receiving the request, the server 300 transmits the original data of the projection image to the projection apparatus 200. Upon receiving the original data, the projection apparatus 200 combines the original data of the projection image received from the server 300 and the data of the processed image received from the PC 100 (by superimposing the data of the processed image on the original data), and projects a resultant image, for example.

Apparatus Configuration

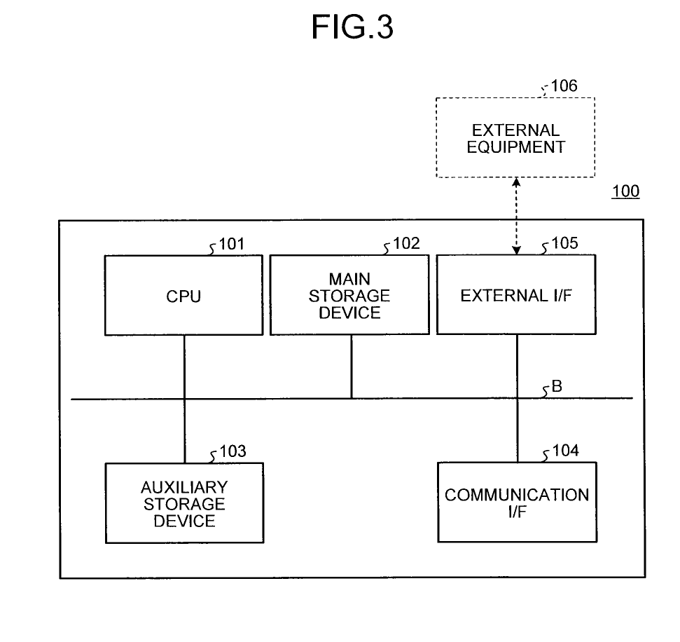

FIG. 3 is a diagram illustrating an example configuration of the PC 100 according to the embodiment. As illustrated in FIG. 3, the PC 100 according to the embodiment includes a central processing unit (CPU) 101, a main storage device 102, an auxiliary storage device 103, a communication interface (I/F) 104, and an external I/F 105 that are connected to each other via a bus B.

The CPU 101 is a computing unit for realizing control of the overall apparatus and installed functions. The main storage device 102 is a storage device (memory) for holding a program, data, and the like in predetermined storage regions. The main storage device 102 can be, for example, a read only memory (ROM) or a random access memory (RAM). The auxiliary storage device 103 is a storage device having a storage capacity higher than that of the main storage device 102. Examples of the auxiliary storage device 103 include non-volatile storage devices such as a hard disk drive (HDD) and a memory card. The auxiliary storage device 103 includes a storage medium such as a flexible disk (FD), a compact disk (CD), or a digital versatile disk (DVD). The CPU 101 realizes control of the overall apparatus and the installed functions by, for example, loading a program and data read out from the auxiliary storage device 103 into the main storage device 102 and executing processing.

The communication I/F 104 is an interface that connects the PC 100 to the data transmission line N. The communication I/F 104 thus allows the PC 100 to carry out data communications with the projection apparatus 200, the server 300, or the image capturing apparatus 400. The external I/F 105 is an interface for exchanging data between the PC 100 and external equipment 106. Examples of the external equipment 106 include a display device (e.g., liquid crystal display) that displays information of various types such as a result of processing, and input devices (e.g., numeric keypad and touch panel) for receiving an operation input. The external equipment 106 includes a drive unit that performs writing/reading to/from an external storage device of high storage capacity and recording media of various types.

The configuration of the projection system 1000 according to the embodiment allows providing an interactive projection function the demand for which arises in a situation where the projection system 1000 is used for digital signage or the like.

Functional Configuration

The projection function according to the embodiment is described below. The projection system 1000 according to the embodiment recognizes an operation (instruction action) performed by a target person and an object (target object) used when performing the operation from a captured image. More specifically, the projection system 1000 recognizes an object, such as stationery, the application purpose of which is known to an unspecified large number of people. After the recognition, the projection system 1000 determines an image processing condition for causing a projection image to reflect the operation performed using the object based on a result of the recognition. The projection system 1000 processes the projection image and projects it according to the determined image processing condition. The projection system 1000 according to the embodiment has such a projection function.

In a situation where digital signage is used to deliver displayed information to an unspecified large number of people, there is a need for an environment that allows a target person to actively interact with the displayed information through intuitive operation. However, because the conventional techniques are intended for users somewhat familiar with electronic equipment operation, and have a problem that the way of operation is hard to understand and handling is difficult for people unfamiliar with electronic equipment operation. Under the circumstances, there is a need for operability facilitating handling by an unspecified large number of people.

Therefore, in the projection function according to the embodiment, an operation performed by a target person and an object used when performing the operation are recognized from a captured image, and based on a result of this recognition, an operation result intended by the target person is reflected into a projection image.

Thus, the projection system 1000 according to the embodiment allows a target person to perform operation intuitively, thereby achieving operability facilitating handling by an unspecified large number of people. Therefore, it is expected that, at a site where the projection system 1000 according to the embodiment is employed, a large number of people will be interested in contents of displayed information because they can interact with the displayed information. Accordingly, the projection system 1000 according to the embodiment can provide an environment that will increase a customer-perceived value, which is desirable for the site.

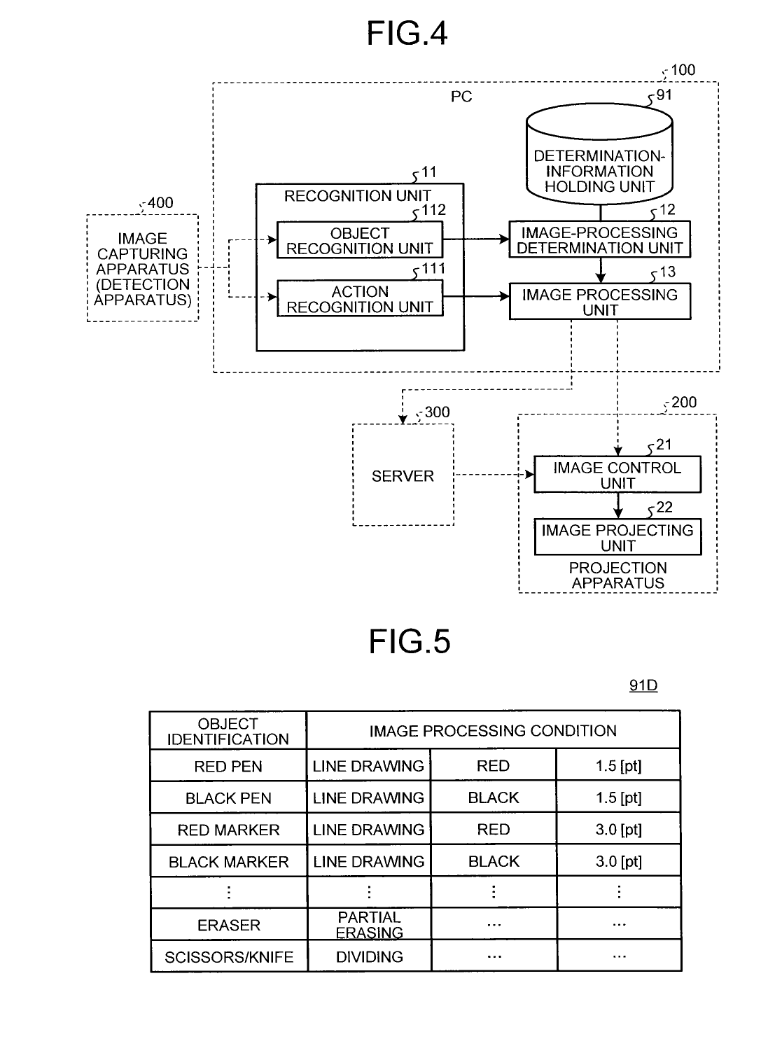

A configuration and operations of the projection function according to the embodiment are described below. FIG. 4 is a diagram illustrating an example configuration of the projection function according to the embodiment. As illustrated in FIG. 4, the projection function according to the embodiment includes a recognition unit 11, an image-processing determination unit 12, an image processing unit 13, an image control unit 21, an image projecting unit 22, and a determination-information holding unit 91. In the embodiment, the PC 100 includes the recognition unit 11, the image-processing determination unit 12, the image processing unit 13, and the determination-information holding unit 91; the projection apparatus 200 includes the image control unit 21 and the image projecting unit 22.

Functions of PC 100

The recognition unit 11 recognizes an operation performed by a target person and an object used when performing the operation. For this purpose, the recognition unit 11 includes an action recognition unit 111 and an object recognition unit 112.

The action recognition unit 111 recognizes an action performed by a target person when performing an operation from a captured image received from the image capturing apparatus 400. In the embodiment, the action recognition unit 111 recognizes an action by, for instance, the following method. The action recognition unit 111 senses a hand of a target person from a captured image of the detection area A, for example, and detects a motion of the hand (motion made by the target person when performing an operation) based on a sensing result. At this time, the action recognition unit 111 detects the motion by performing predetermined data conversion. When the action recognition unit 111 detects that the hand is moving in the detection area A, the action recognition unit 111 converts a result of this detection (i.e., detected instruction action) to a plurality of coordinates. As a result, the action recognition unit 111 obtains an amount of displacement from an action-start position (hereinafter, “operation-start position”) and an action-end position (hereinafter, “operation-end position”). The displacement amount is obtained as coordinates from the operation-start position to the operation-end position. The action recognition unit 111 recognizes an operation performed by a target person by the foregoing method.

The object recognition unit 112 recognizes an object used by the target person when performing the operation from the captured image received from the image capturing apparatus 400. In the embodiment, the object recognition unit 112 recognizes the object by, for instance, the following method. The object recognition unit 112 senses the hand of the target person from the captured image of the detection area A, for example, and detects the object (object used when performing the operation) held by the hand based on a sensing result. In short, the object recognition unit 112 senses the hand of the target person holding the object and detects the object held by the hand. At this time, the object recognition unit 112 detects the object by performing predetermined data processing. For example, the object recognition unit 112 collects data about features of objects (e.g. objects the application purposes of which are known to an unspecified large number of people), such as stationery, that can be used in an operation and stores the data as feature data in advance. Examples of the feature data include image data and geometry data about the objects. The object recognition unit 112 performs image processing on captured image of the detection area A and compares a result (result of detecting the target object) of extracting image features against the stored feature data, thereby determining whether or not the extraction result matches the feature data. Examples of the image features include color, density, and pixel change. When the result of extraction from the object matches the feature data, the object recognition unit 112 determines that the object is a recognized object, and obtains information (hereinafter, “object identification information”) for identification of the object. A configuration may be employed in which the feature data is stored in, for example, a predetermined storage region of the auxiliary storage device 103 of the PC 100. When this configuration is employed, the object recognition unit 112 refers to the feature data by accessing the auxiliary storage device 103 when performing object recognition. The object recognition unit 112 recognizes an object used when performing an operation by the foregoing method.

As described above, in the embodiment, the image capturing apparatus 400 serves as a detection apparatus that detects an instruction action performed by a target person and a target object; the captured image serves as detection information. Accordingly, the recognition unit 11 recognizes an instruction action performed by a target person toward a projection image and a target object based on detection information obtained by the detection apparatus.

The image-processing determination unit 12 determines an image processing condition (what image processing is to be performed on the projection image, toward which the operation is performed) to be applied to the projection image, toward which the operation is performed. That is, the image-processing determination unit 12 determines the image processing condition for causing the operation performed using the object to be reflected into the projection image based on the result of recognizing the object used when performing the operation. In the embodiment, the image processing condition are determined by, for instance, the following method. The image-processing determination unit 12 accesses a determination-information holding unit 91 to identify an image processing condition associated with the recognized object by referring to determination information held by the determination-information holding unit 91 based on the result of recognizing the object, thereby determining the image processing condition. The determination-information holding unit 91 can be a predetermined storage region of the auxiliary storage device 103 of the PC 100.

The determination information according to the embodiment is described below.

Determination Information

FIG. 5 is a diagram illustrating a data example of determination information 91D according to the first embodiment. As illustrated in FIG. 5, the determination information 91D according to the embodiment has information items, such as an object identification and an image-processing condition, that are associated with each other. The object identification item is an item where object identification information is to be defined. Examples of the item value include names of stationery, such as red pen, black pen, red marker, black marker, eraser, scissors, and knife, and product codes (product identifiers). The image-processing condition item is an item where one or a plurality of pieces of condition information (hereinafter, “image-processing condition information”) associated with an object is to be defined. Examples of the item value include image-processing type values, such as line drawing, partial erasing, and dividing, and image-processing attribute values, such as red, black, and number of points (hereinafter, “pt”). Thus, the determination information 91D according to the embodiment serves as definition information, in which the object identification information and the image-processing condition information are associated with each other.

The data structure described above allows the determination information 91D according to the embodiment to associate each recognition-target object with a corresponding image processing condition, which are to be applied to a projection image when an operation is performed toward the image using the recognition-target object. More specifically, the determination information 91D can associate the each object with a type(s) and an attribute(s) of image processing to be performed on the projection image, toward which the operation is performed using the object. For this purpose, the PC 100 accepts settings of an image processing condition (i.e., settings of image processing condition that cause an operation performed using a recognized object to be reflected into a projection image) to be applied to a recognized object prior to recognizing the object (i.e., before the projection system 1000 is brought into operation) in advance. The accepted settings of condition are stored in the PC 100 as information item values of the determination information 91D. The image-processing determination unit 12 identifies image-processing condition information associated with the object identification information by referring to the object identification information and the image-processing condition information configured as described above. The image-processing determination unit 12 thus determines image processing condition for reflecting the operation performed using the object into the projection image.

For example, in a case where the image-processing determination unit 12 refers to the determination information 91D illustrated in FIG. 5, an image processing condition is determined as follows. Assume that, for instance, the object recognition unit 112 recognizes “red pen” as an object used in an operation. In this case, the image-processing determination unit 12 refers to the object identification information in the determination information 91D to determine whether or not the recognized “red pen” is a previously-registered object (object that is supposed to be used in an operation) depending on whether or not the object identification information contains object identification information about the “red pen”. When a result of this determination is that the recognized “red pen” is a previously-registered object (i.e., object identification information about the “red pen” is contained), the image-processing determination unit 12 identifies image-processing condition information associated with the object identification information about the “red pen”. In this case, the image-processing determination unit 12 identifies an image-processing type value “line drawing” and image-processing attribute values “red” and “1.5 pt” that are associated with the recognized “red pen”. As a result, the image-processing determination unit 12 determines an image processing condition of drawing a red line of 1.5 pt for the recognized “red pen”. Similarly, when the object recognition unit 112 recognizes “eraser”, the image-processing determination unit 12 determines an image processing condition of performing partial image erasing for the recognized “eraser”. When the object recognition unit 112 recognizes “scissors” or “knife”, the image-processing determination unit 12 determines an image processing condition of performing image dividing. The image-processing determination unit 12 determines an image processing condition to be applied to a projection image, toward which an operation is performed, by the foregoing method.

The image processing unit 13 generates a processed image for the projection image. The image processing unit 13 generates the processed image according to the determined image-processing condition. In the embodiment, the processed image is generated by, for instance, the following method. The image processing unit 13 generates, for example, a transparent image of a same size as the projection image. Subsequently, the image processing unit 13 performs image drawing on the transparent image according to the image processing condition determined by the image-processing determination unit 12 based on the amount of displacement obtained by the action recognition unit 111. For instance, in a case where the image-processing determination unit 12 determines image processing of drawing a red line of 1.5 pt for a recognized “red pen”, the image processing unit 13 draws an image of a red line of 1.5 pt on the transparent image based on the coordinates from the operation-start position to the operation-end position. In a case where the image-processing determination unit 12 determines image processing of performing partial image erasing for a recognized “eraser”, the image processing unit 13 draws, on the transparent image, a white image corresponding to an area to be erased based on the coordinates from the operation-start position to the operation-end position. In a case where the image-processing determination unit 12 determines image processing of performing image dividing for recognized “scissors” or “knife”, the image processing unit 13 draws, on the transparent image, a white line corresponding to a split line based on the coordinates from the operation-start position to the operation-end position. The image processing unit 13 generates a processed image that causes an operation result intended by a target person to be reflected into a projection image by the foregoing method. Thereafter, the image processing unit 13 transmits data of the generated processed image to the projection apparatus 200. Simultaneously, the image processing unit 13 requests the server 300 to transmit original data of the projection image to the projection apparatus 200.

Functions of Projection Apparatus 200

The image control unit 21 controls image projection. More specifically, the image control unit 21 controls image projection onto the projection surface S based on the processed image. In the embodiment, the image control unit 21 controls image projection by, for instance, the following method. The image control unit 21 combines the original data of the projection image received from the server 300 and the data of the processed image received from the PC 100. More specifically, the image control unit 21 generates a combined image of the original data of the projection image received from the server 300 and the data of the processed image received from the PC 100 by superimposing the data of the processed image on the original data of the projection image. For example, in a case where the image processing unit 13 has generated a processed image on which an image of a red line of 1.5 pt is drawn, the image control unit 21 generates a combined image, in which the image of the red line of 1.5 pt is superimposed on the projection image. In a case where the image processing unit 13 has generated a processed image on which a white image corresponding to an area to be erased is drawn, the image control unit 21 generates a combined image, in which the white image is superimposed on the projection image at an area to be erased. In a case where the image processing unit 13 has generated a processed image on which a white line corresponding to a split line is drawn, the image control unit 21 generates a combined image, in which the projection image is divided by the white image superimposed on the projection image. The image control unit 21 controls image projection onto the projection surface S by generating a combined image, in which an operation result intended by a target person is reflected into a projection image, by using the foregoing method.

The image projecting unit 22 performs image projection using a projection engine. The image projecting unit 22 performs image projection by transferring the image (e.g., the combined image) resultant from the control performed by the image control unit 21 to the projection engine and instructing the projection engine to project the image.

As described above, the projection function according to the embodiment is implemented by collaborative operation of the functional units. More specifically, executing a program on the PC 100, the projection apparatus 200, and the server 300 causes the functional units to collaboratively operate.

The program can be provided as being recorded in an installable or executable format in non-transitory storage media readable by the respective apparatuses (computers) in an execution environment. For example, in the PC 100, the program may have a module structure including the functional units described above. The CPU 101 reads out the program from a storage medium of the auxiliary storage device 103 and executes the program, thereby generating the functional units on a RAM of the main storage device 102. A method for providing the program is not limited thereto. For instance, a method of storing the program in external equipment connected to the Internet and downloading the program via the data transmission line N may be employed. Alternatively, a method of providing the program by storing them in a ROM of the main storage device 102 or an HDD of the auxiliary storage device 103 in advance may be employed.

Processing (collaborative operation among the functional units included in the apparatuses) in the projection system 1000 according to the embodiment is described below with reference to flowcharts.

Processing by Image Capturing Apparatus 400

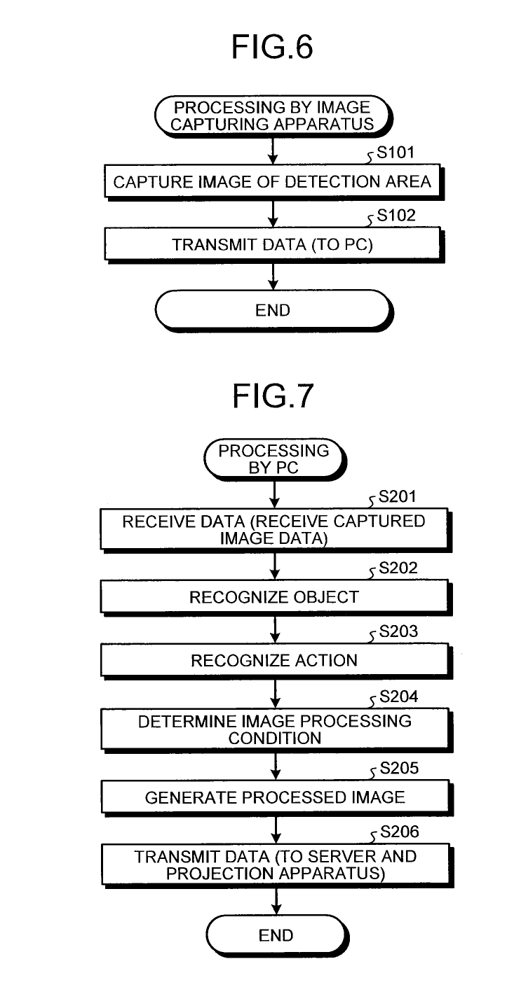

FIG. 6 is a flowchart illustrating an example of processing by the image capturing apparatus 400 according to the embodiment. As illustrated in FIG. 6, the image capturing apparatus 400 according to the embodiment captures an image of the detection area A (Step S101), and transmits captured image data to the PC 100 (Step S102). The data to be transmitted from the image capturing apparatus 400 to the PC 100 can be any data including the image of the detection area A irrespective of whether the data is still image or motion video.

Processing by PC 100

FIG. 7 is a flowchart illustrating an example of processing by the PC 100 according to the embodiment. As illustrated in FIG. 7, the PC 100 according to the embodiment receives the captured image data of the detection area A transmitted from the image capturing apparatus 400 (Step S201).

Upon receiving the data, the object recognition unit 112 of the PC 100 recognizes an object used by a target person when performing an operation (Step S202). More specifically, the object recognition unit 112 senses a hand of the target person from the received captured image of the detection area A, and detects the object (the object used when performing the operation) held by the hand based on a sensing result. The object recognition unit 112 obtains object identification information about the detected object.

Subsequently, the action recognition unit 111 of the PC 100 recognizes an action performed by the target person when performing the operation (Step S203). More specifically, the action recognition unit 111 senses the hand of the target person from the received captured image of the detection area A, and detects a motion of the hand (motion made by the target person when performing the operation) based on a sensing result. The action recognition unit 111 obtains an amount of displacement (coordinates from an operation-start position to an operation-end position) corresponding to the detected motion.

Subsequently, the image-processing determination unit 12 of the PC 100 determines an image processing condition to be applied to a projection image, toward which the operation is performed (Step S204). More specifically, the image-processing determination unit 12 accesses the determination-information holding unit 91 and refers to the determination information 91D held by the determination-information holding unit 91 based on the result of recognizing the object by the recognition unit 11. The image-processing determination unit 12 determines an image processing condition corresponding to the recognized object by identifying image-processing condition information associated with object identification information of the recognized object from the determination information 91D.

Subsequently, the image processing unit 13 of the PC 100 generates a processed image for the projection image (Step S205). More specifically, the image processing unit 13 generates the processed image by performing image drawing according to the image processing condition determined by the image-processing determination unit 12.

Subsequently, the PC 100 transmits data of the generated processed image to the projection apparatus 200 (Step S206). Simultaneously, the PC 100 transmits to the server 300 a request for transmission of original data of the projection image to the projection apparatus 200.

Processing by Server 300

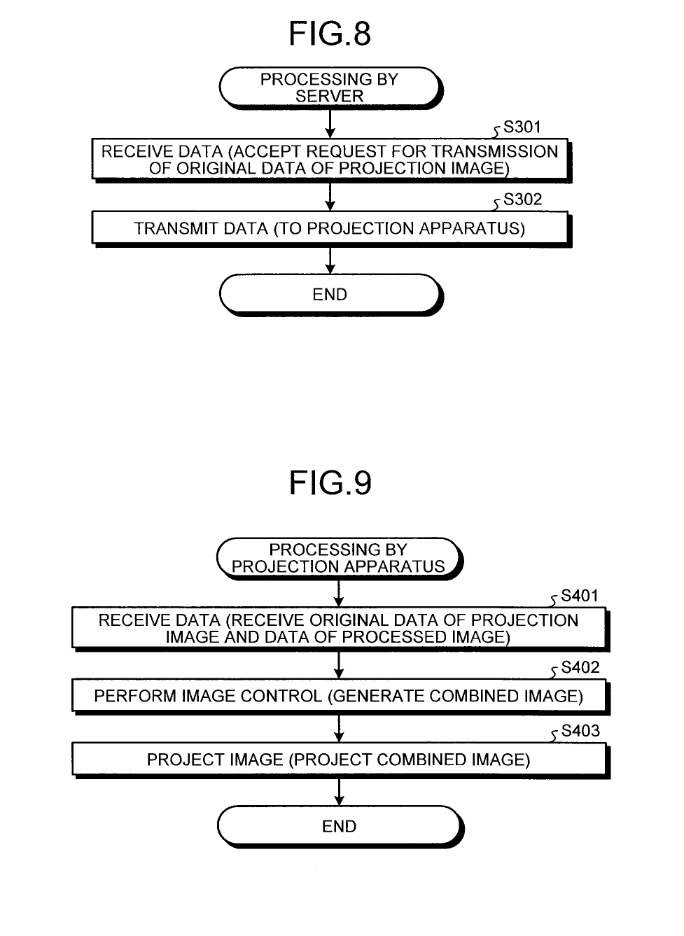

FIG. 8 is a flowchart illustrating an example of processing by the server 300 according to the embodiment. As illustrated in FIG. 8, the server 300 according to the embodiment receives the data transmitted from the PC 100 (Step S301). The received data is, more specifically, the request (request command) for transmission of the original data of the projection image to the projection apparatus 200. Accordingly, the server 300 receives the request command, thereby accepting a data transmission request.

In response to the request, the server 300 transmits the original data of the projection image to the projection apparatus 200 (Step S302).

Processing by Projection Apparatus 200

FIG. 9 is a flowchart illustrating an example of processing by the projection apparatus 200 according to the embodiment. As illustrated in FIG. 9, the projection apparatus 200 according to the embodiment receives the original data of the projection image transmitted from the server 300 and the data of the processed image transmitted from the PC 100 (Step S401).

Upon receiving the data, the image control unit 21 of the projection apparatus 200 controls image projection onto the projection surface S based on the processed image (Step S402). More specifically, the image control unit 21 generates a combined image of the projection image and the processed image by superimposing the data of the processed image on the original data of the projection image, for example.

Subsequently, the image projecting unit 22 of the projection apparatus 200 projects the image resultant from the control performed by the image control unit 21 (Step S403). More specifically, for example, the image projecting unit 22 transfers the combined image to the projection engine and instructs the projection engine to project the image.

As described above, the projection system 1000 according to the embodiment recognizes an operation performed by a target person and an object used when performing the operation from a captured image of the detection area A. The projection system 1000 determines an image processing condition for causing a projection image to reflect the operation performed using the object based on a result of the recognition. The projection system 1000 processes the projection image and projects it according to the determined image processing condition. The projection system 1000 causes an operation result intended by a target person to be reflected into a projection image in this manner.

Processing for determining image processing and processing for processing an image to be performed by the PC 100 according to the embodiment are described below with reference to flowcharts.

Processing for Determining Image Processing

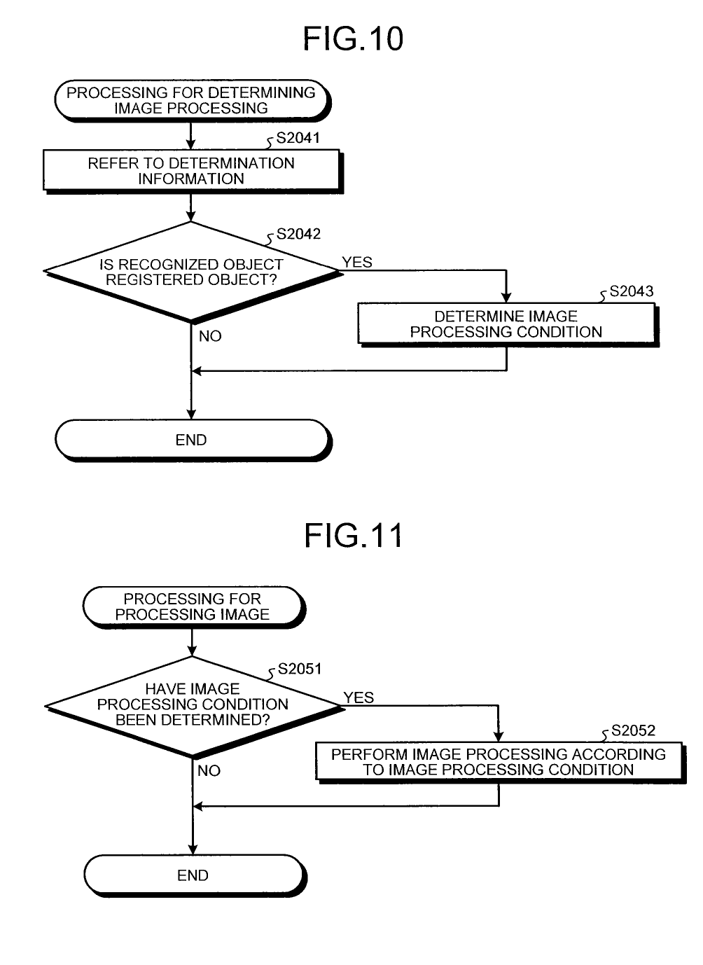

FIG. 10 is a flowchart illustrating an example of processing for determining image processing according to the embodiment. Processing illustrated in FIG. 10 is a detail of Step S204 (performed by the image-processing determination unit 12) of FIG. 7.

As illustrated in FIG. 10, the image-processing determination unit 12 according to the embodiment accesses the determination-information holding unit 91 to refer to the determination information 91D based on object identification information of a recognized object (Step S2041).

The image-processing determination unit 12 determines whether or not the recognized object is already registered in the determination information 91D based on a result of referring to the object identification information (Step S2042). More specifically, the image-processing determination unit 12 determines whether or not the recognized object is already registered in the determination information 91D by determining whether or not an object recognition item of the determination information 91D includes an item value that matches the object identification information of the recognized object.

When, as a result, the image-processing determination unit 12 determines that the recognized object is already registered in the determination information 91D (Yes in Step S2042), the image-processing determination unit 12 determines an image-processing condition corresponding to the recognized object (Step S2043). More specifically, the image-processing determination unit 12 determines an image processing condition to be applied to a projection image, toward which an operation is performed, by identifying an item value (image-processing condition information) in the image-processing condition item associated with the object recognition item that matches the object identification information of the recognized object.

On the other hand, when the image-processing determination unit 12 determines that the recognized object is not registered in the determination information 91D (No in Step S2042), the image-processing determination unit 12 does not determine an image processing condition corresponding to the recognized object.

The image-processing determination unit 12 according to the embodiment determines image processing to be performed on a projection image in a case where an object used in an operation is registered in the determination information 91D in this manner.

Processing for Generating Processed Image

FIG. 11 is a flowchart illustrating an example of processing for generating a processed image according to the embodiment. Processing illustrated in FIG. 11 is a detail of Step S205 (performed by the image processing unit 13) of FIG. 7.

As illustrated in FIG. 11, the image processing unit 13 according to the embodiment determines whether or not an image processing condition to be applied to the projection image, toward which the operation is performed, has been determined (Step S2051). More specifically, the image processing unit 13 determines whether or not an image processing condition has been determined by determining whether or not image-processing condition information has been received from the image-processing determination unit 12.

When, as a result, the image processing unit 13 determines that the image processing condition to be applied to the projection image, toward which the operation is performed, has been determined (Yes in Step S2051), the image-processing determination unit 12 performs image processing according to the determined image processing condition (Step S2052). More specifically, the image processing unit 13 generates a processed image by performing image drawing according to the image processing condition determined by the image-processing determination unit 12.

On the other hand, when the image processing unit 13 determines that the image processing condition to be applied to the projection image, toward which the operation is performed, have not been determined (No in Step S2051), the image-processing determination unit 12 does not perform image processing.

As described above, the image processing unit 13 according to the embodiment performs image processing on a projection image, toward which an operation is performed, in a case where image processing has been determined by the image-processing determination unit 12.

### CONCLUSION

As described above, according to the projection system 1000 of the embodiment, the recognition unit 11 recognizes an operation performed by a target person and an object used when performing the operation from a captured image. More specifically, the recognition unit 11 recognizes an object, e.g., stationery, the application purpose of which is known to an unspecified large number of people. When this recognition has been made, the image-processing determination unit 12 of the projection system 1000 determines an image processing condition for causing a projection image to reflect the operation performed using the object based on a result of the recognition. Subsequently, the image processing unit 13 of the projection system 1000 generates a processed image according to the determined image processing condition. When the processed image has been generated, the image control unit 21 of the projection system 1000 controls image projection onto the projection surface S based on the processed image. The image projecting unit 22 of the projection system 1000 projects an image resultant from the control performed by the image control unit 21.

In short, the projection system 1000 according to the embodiment provides an environment, in which an operation performed by a target person and an object used when performing the operation are recognized from a captured image; an operation result intended by the target person is reflected into a projection image based on a result of the recognition.

Thus, the projection system 1000 according to the embodiment allows even a person unfamiliar with electronic equipment operation to operate the projection system 1000 intuitively based on an application purpose of an object used in the operation. Therefore, it is expected that, at a site where the projection system 1000 according to the embodiment is employed, a large number of people will be interested in contents of displayed information because they can interact with the displayed information. Accordingly, the projection system 1000 according to the embodiment can provide an environment that will increase a customer-perceived value to the site where the projection system 1000 is employed.

In the embodiment, an example in which functions of the projection system 1000 are implemented by software is described. However, an employable configuration is not limited thereto. For example, a part or all of the functional units may be implemented by hardware (e.g., “circuit”).

In the embodiment, an example in which the object used in the operation is stationery is described. However, an employable configuration is not limited thereto. The object that would conceivably be used in an operation can be any object the application purpose of which is known to an unspecified large number of people.

Modifications of the embodiment are described below. In the description below, elements identical to those of the embodiments are denoted by like reference numerals, and repeated description is omitted; only different elements are described below.

First Modification

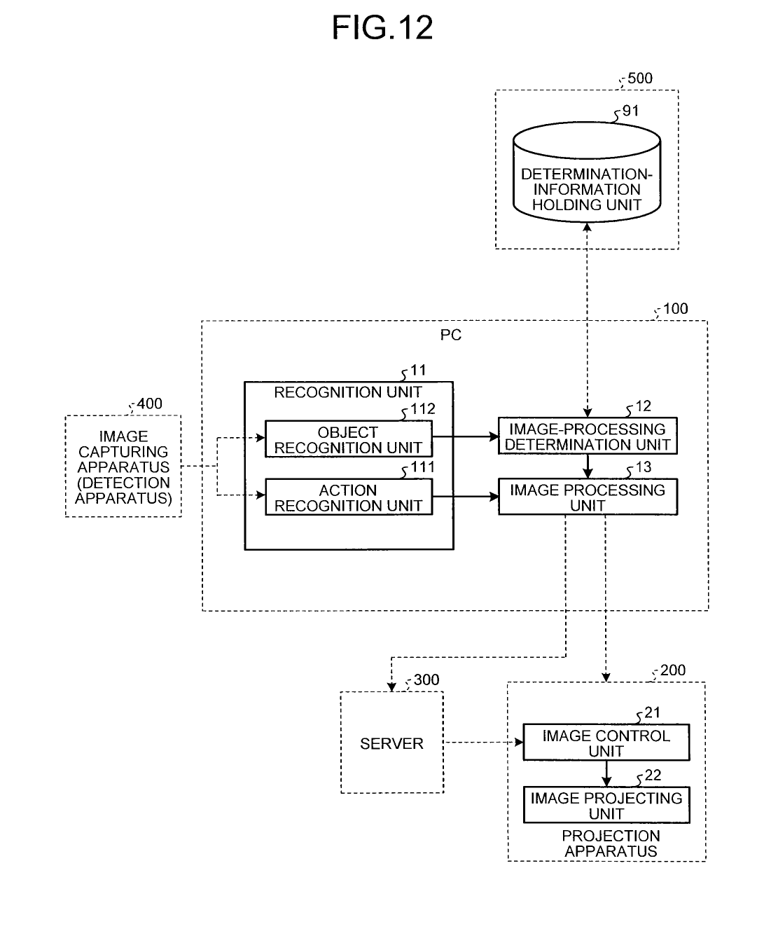

FIG. 12 is a diagram illustrating an example configuration of a projection function according to a first modification. As illustrated in FIG. 12, in the projection function according to the first modification, an external storage device (external storage) 500 includes the determination-information holding unit 91. Data communications with the external storage device 500 can be carried out via, for example, the communication I/F 104 or the external I/F 105 included in the PC 100. Like this, the determination-information holding unit 91 is not necessarily a predetermined storage region in the auxiliary storage device 103 included in the PC 100. In other words, the determination-information holding unit 91 can be any storage region accessible from the image-processing determination unit 12.

As described above, the projection function according to the first modification provides an effect similar to that provided by the embodiment. Furthermore, the projection function according to the first modification allows simplifying management of the determination information 91D for use in determining image processing by sharing the determination information 91D among a plurality of the PCs 100 each having the image-processing determination unit 12.

Second Modification

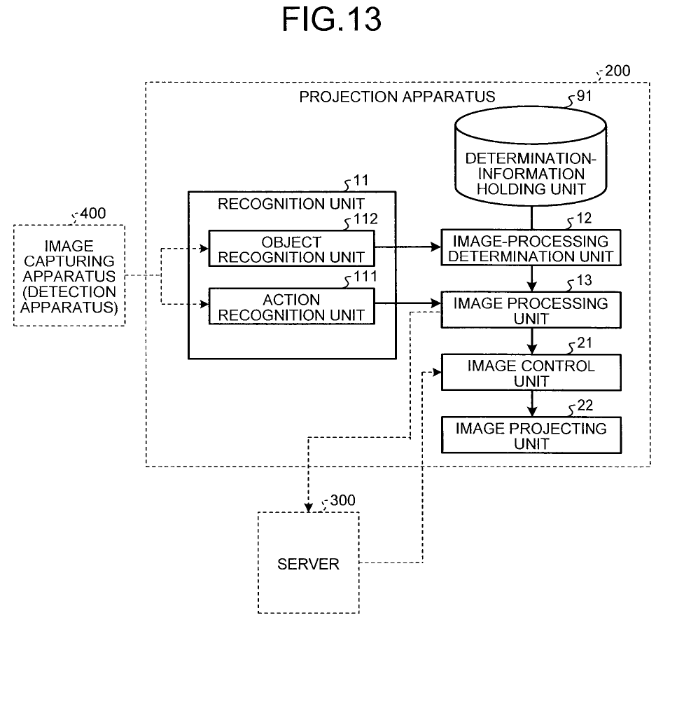

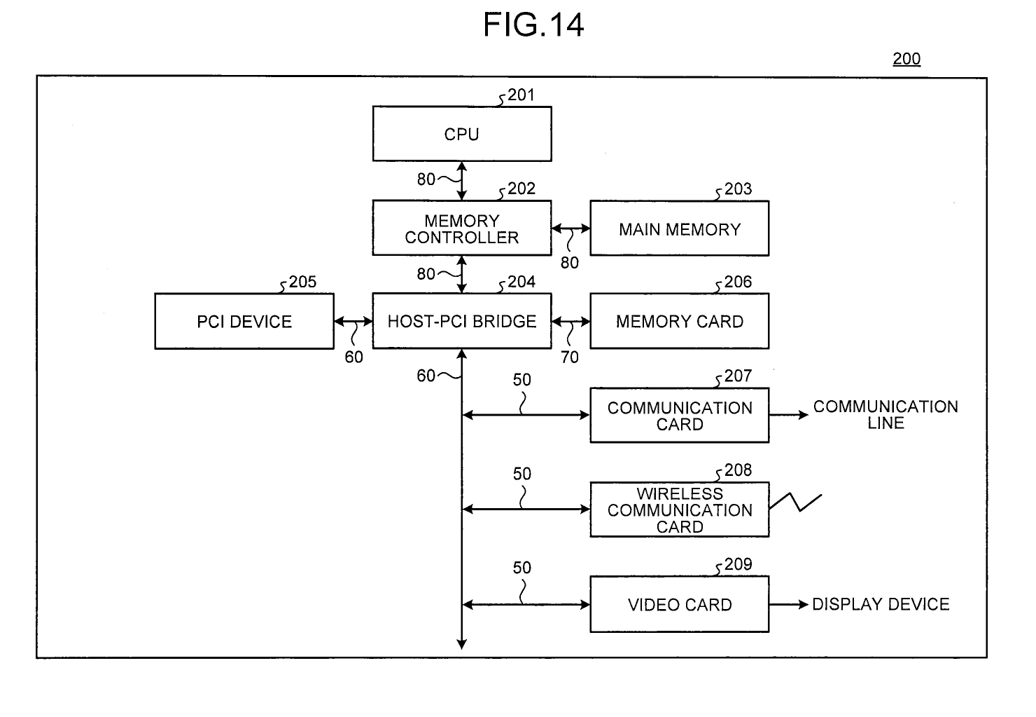

FIG. 13 is a diagram illustrating an example configuration of a projection function according to a second modification. As illustrated in FIG. 13, in the projection function according to the second modification, the projection apparatus 200 includes, in addition to the image control unit 21 and the image projecting unit 22, the recognition unit 11, the image-processing determination unit 12, the image processing unit 13, and the determination-information holding unit 91. The projection function according to the second modification is implemented by executing a program on the projection apparatus 200 configured as illustrated in FIG. 14, for example, thereby causing the functions to collaboratively operate.

FIG. 14 is a diagram illustrating an example configuration of the projection apparatus 200 according to the second modification. As illustrated in FIG. 14, the projection apparatus 200 according to the second modification includes a CPU 201, a memory controller 202, a main memory 203, and a host-PCI (peripheral component interconnect) bridge 204.

The memory controller 202 is connected to the CPU 201, the main memory 203, and the host-PCI bridge 204 via a host bus 80.

The CPU 201 is a computing unit for controlling the overall projection apparatus 200. The memory controller 202 is a control circuit that controls reading/writing from/to the main memory 203. The main memory 203 is a semiconductor memory for use as, for example, a storing memory for storing a program and data therein, a memory for loading a program and data thereinto, or a memory for use in drawing.

The host-PCI bridge 204 is a bridge circuit for connecting a peripheral device and a PCI device 205. The host-PCI bridge 204 is connected to a memory card 206 via an HDD I/F 70. The host-PCI bridge 204 is also connected to the PCI device 205 via a PCI bus 60. The host-PCI bridge 204 is also connected to a communication card 207, a wireless communication card 208, and a video card 209 via the PCI bus 60 and PCI slots 50.

The memory card 206 is a storage medium used as a boot device of basic software (operating system (OS)). The communication card 207 and the wireless communication card 208 are communication control devices for connecting the apparatus to a network or a communication line and controlling data communication. The video card 209 is a display control device that controls image display by outputting a video signal to a display device connected to the apparatus. Meanwhile, a control program to be executed by the projection apparatus 200 according to the second modification may be provided as being stored in the storing memory of the main memory 203 or the like.

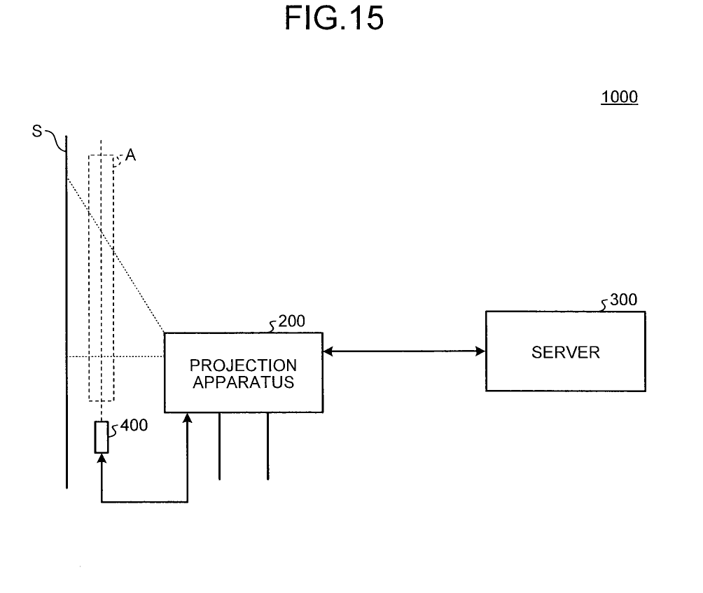

As described above, the projection function according to the second modification provides an effect similar to that provided by the embodiment. Furthermore, because the functions are implemented by the projection apparatus 200 alone, the system can be simplified as illustrated in FIG. 15, for example.

FIG. 15 is a schematic drawing of the projection system 1000 according to the second modification. As illustrated in FIG. 15, in the projection system 1000 according to the second modification, the image capturing apparatus 400 transmits captured image data of the detection area A to the projection apparatus 200. From the received captured image data, the projection apparatus 200 recognizes an operation performed by a target person and an object used when performing the operation and performs image processing for reflecting the operation performed by the target person using the object into a projection image. Thereafter, the projection apparatus 200 requests the server 300 to transmit original data of the projection image. In response to the request, the server 300 transmits the original data of the projection image to the projection apparatus 200. The projection apparatus 200 combines, for example, the original data of the projection image received from the server 300 and data of a processed image (i.e., superimposes the data of the processed image on the original data), and projects a resultant image.

The embodiment provides an advantageous effect that operability facilitating handling by an unspecified large number of people is achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A projection system comprising:
a projecting unit that projects an image;
a recognition unit that recognizes an instruction action performed by a target person toward an image projected by the projecting unit and a target object based on detection information obtained by a detection apparatus;
a determination unit that determines a processing condition to be applied to the image based on a recognition result by the recognition unit;
a processing unit that processes the image according to the processing condition determined by the determination unit; and
a control unit that controls image projection performed by the projection unit based on the image processed by the processing unit.

2. The projection system according to claim 1, wherein
the recognition unit includes an action recognition unit that converts a result of detecting the instruction action into a plurality of coordinates, the result being contained in the detection information, and obtains an amount of displacement from an action-start position to an action-end position, and
the processing unit processes the image by performing image drawing according to the image processing condition determined by the determination unit and based on the amount of displacement obtained by the action recognition unit.

3. The projection system according to claim 1, wherein
the recognition unit includes an object recognition unit that obtains object identification information about the target object based on a result of detecting the target object, the result being contained in the detection information, and
the determination unit determines the processing condition by referring to definition information, in which the target object and processing condition information indicative of the processing condition to be applied to the target object are associated with each other, and identifying the processing condition information associated with the object identification information obtained by the object recognition unit.

4. The projection system according to claim 1, wherein the control unit generates a combined image by superimposing the processed image processed by the processing unit on the image projected by the projection unit.

5. The projection system according to claim 1, wherein the detection information is an image obtained by capturing an image of a detection area where the instruction action and the target object are to be detected.

6. A projection apparatus comprising:
a projecting unit that projects an image;
a recognition unit that recognizes an instruction action performed by a target person toward an image projected by the projecting unit and a target object based on detection information obtained by a detection apparatus;
a determination unit that determines processing condition to be applied to the image based on a recognition result by the recognition unit;
a processing unit that processes the image according to the processing condition determined by the determination unit; and
a control unit that controls image projection performed by the projection unit based on the image processed by the processing unit.

7. The projection apparatus according to claim 6, wherein
the recognition unit includes an action recognition unit that converts a result of detecting the instruction action into a plurality of coordinates, the result being contained in the detection information, and obtains an amount of displacement from an action-start position to an action-end position, and
the processing unit processes the image by performing image drawing according to the image processing condition determined by the determination unit and based on the amount of displacement obtained by the action recognition unit.

8. The projection apparatus according to claim 6, wherein
the recognition unit includes an object recognition unit that obtains object identification information about the target object based on a result of detecting the target object, the result being contained in the detection information, and
the determination unit determines the processing condition by referring to definition information, in which the target object and processing condition information indicative of the processing condition to be applied to the target object are associated with each other, and identifying the processing condition information associated with the object identification information obtained by the object recognition unit.

9. The projection apparatus according to claim 6, wherein the control unit generates a combined image by superimposing the processed image processed by the processing unit on the image projected by the projection unit.

10. The projection apparatus according to claim 6, wherein the detection information is an image obtained by capturing an image of a detection area where the instruction action and the target object are to be detected.

11. A projection method comprising:
projecting an image;
recognizing an instruction action performed by a target person toward an image projected by the projecting unit and a target object based on detection information obtained by a detection apparatus;
determining processing condition to be applied to the image based on a recognition result at the recognizing;
processing the image according to the processing condition determined at the determining; and
controlling image projection performed at the projecting based on the processed image obtained at the processing.
